(19) United States
(12) Patent Application Publication
(10) Pub. No.: US 2010/0325528 A1
(43) Pub. Date: Dec. 23, 2010

(54) AUTOMATED FORMATTING BASED ON A STYLE GUIDE

(76) Inventors: Arcie V. Ramos,, SR., El Mirage, AZ (US); David L. Smith, JR., Chandler, AZ (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/510,202

(22) Filed: Jul. 27, 2009

Related U.S. Application Data
(60) Provisional application No. 61/218,023, filed on Jun. 17, 2009.

(51) Int. Cl. G06F 17/21; G06F 17/00

(52) U.S. Cl. 715/230; 715/256; 715/236

(57) ABSTRACT

Techniques are provided for organizing information in a document according to the rules of a particular style guide. Information for full references is collected and stored as both reference metadata in the metadata of the document, and as reference text in one or more locations in the text of the document. As information for a particular reference is input into a GUI, a depiction of reference text for the reference is automatically updated to reflect each new item of information, such that the depiction continually conforms to the rules of the particular style guide. A user may insert in-text citations, based on reference metadata in the metadata of the document, into the text of the document. A formatted in-text citation may be presented to a user for editing. The edited in-text citation is automatically inserted into the text of the document at a location indicated by the user.

### CROSS-REFERENCE TO BENEFIT CLAIM

This application claims benefit of Provisional Application 61/218,023, filed Jun. 17, 2009, entitled “Style Guide Formatter,” the entire contents of which is hereby incorporated by reference as if fully set forth herein, under 35 U.S.C. §119(e).

### FIELD OF THE INVENTION

The present invention relates to techniques for automatically formatting a document according to the rules of a particular style guide, and specifically to a portable and flexible method of tracking information that is to be formatted according to the style rules that may be specified in a style guide.

### BACKGROUND

Style guides, such as the American Psychological Association (APA) style guide or the Modern Language Association (MLA) style guide, etc., provide sets of rules with detailed guidance for formatting the information in documents such as research papers. Such style guides may include rules governing document features, e.g., margin size, font type and size, paragraph style, title page style, reference formatting, etc. Many schools and professional associations require that documents submitted thereto conform to a particular style guide.

However, it is challenging to conform documents to all of the rules of a particular style guide. Tools that have historically been developed to help guide an author through the rules of a particular style guide generally store information submitted by the author in databases that are separate from the document being developed, and accessible only to the author. For example, a file containing the database for a document may be stored on the hard drive of the computer system of the author that initially created the document. Therefore, if the author must work with one or more other authors to write the document, the other authors may not have convenient access to information stored by such tools. Information that is only accessible to one author may hinder the progression and consistency of formatting of such a group document.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example method of creating and populating a new document.

FIG. 2 represents a graphical user interface used to collect a user's name and institution information.

FIG. 3 represents a graphical user interface used to collect information for a title page and page headers of a document.

FIG. 4 represents a graphical user interface used to determine whether an abstract should be included in a document.

FIG. 5 illustrates an example method of collecting information for a new reference.

FIG. 6 represents a graphical user interface having UI controls that, when activated, convey requests to insert citations into a document, to view the title page editor for the document, and create and add reference information into the document.

FIG. 7 represents a graphical user interface used to determine a reference type for reference information to be inserted into a document.

FIGS. 8A-8D represent a graphical user interface used to collect reference information for a particular type of reference, i.e., a book reference.

FIG. 9 illustrates an example method of updating a formatted depiction of a particular reference included in a graphical user interface.

FIG. 10 illustrates an example method of inserting reference information as both text and metadata into a document.

FIGS. 11A-11B illustrate example reference sections for the text of a document.

FIG. 12 illustrates a graphical user interface from which a user may add a reference to a document, remove a reference from the document, select a particular reference for an in-text citation, and rebuild a reference section in the text of the document based on the metadata of the document.

FIG. 13 illustrates an example method of formatting an in-text citation based on a particular reference, and automatically inserting the formatted citation text at a particular location in the document.

FIGS. 14A-14B illustrate inserting an in-text citation at a particular location in the text of a document indicated by a user.

FIG. 15 illustrates an example method of receiving user input that edits citation text and inserting the edited citation text into the text of the document.

FIGS. 16A-16B illustrate a graphical user interface that displays, for editing by a user, an in-text citation.

FIG. 17 illustrates user-edited citation text being inserted into a location indicated by a user.

FIGS. 18A-18B illustrate a graphical user interface that allows a user to insert an in-text citation for a pre-formatted reference.

FIG. 19 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Functional Overview

Techniques are provided for organizing information in a document according to the rules of a particular style guide. A user is guided through the initial set up of a document, including gathering information for a title page, page headers, and abstract. The document is populated with the provided information and is formatted according to the rules of the particular style guide, i.e., using the functionality of a word processing application.

Information for full references is collected and stored as both reference metadata in the metadata of the document, and as reference text in one or more locations in the text of the document. Because all data for the document is stored in the document itself, as text and document metadata, no auxiliary files are necessary for the embodiments of the invention. As information for a particular reference is input into a graphical user interface (GUI), a depiction of reference text for the reference is automatically updated to reflect each new item of information, such that the depiction continually conforms to the rules of the particular style guide.

A user may insert in-text citations, based on reference metadata in the metadata of the document, into the text of the document. Upon a user's request to insert such an in-text citation based on a particular reference, information for the in-text citation is gathered from the metadata of the document and formatted according to the rules of the particular style guide. The formatted in-text citation is then presented to a user for editing. The edited in-text citation is automatically inserted into the text of the document at a location indicated by the user.

### Creating and Populating a Document

For purposes of illustration, an example tool is discussed herein that is configured to guide a user in conforming documents to the rules of a particular style guide, according to certain embodiments of the invention. For purposes of illustration, the following description shows this example tool as implementing the rules of the APA style guide. However, any style guide with rules for formatting documents may be implemented within the embodiments of the invention.

The particular style guide being applied by the example tool may be selected in many ways. For example, the rules of a single style guide may be built into the tool, or a user may choose one of a plurality of style guides for application by the tool, etc.

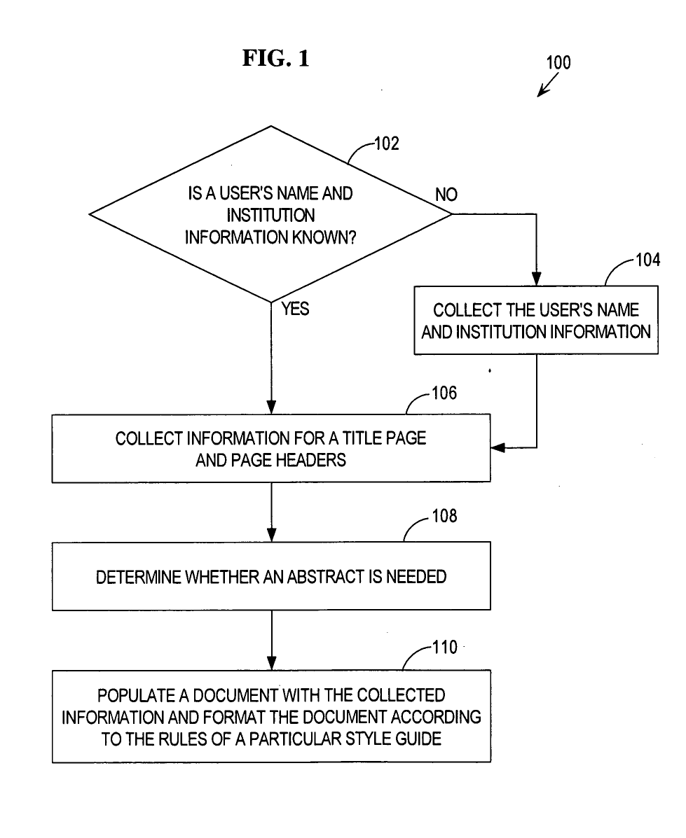

FIG. 1 illustrates an example method 100 of creating a particular document and populating the document with information formatted according to the rules of a particular style guide. The steps of example method 100 are not limited to the ordering shown in FIG. 1.

At step 102, it is determined whether a user's name and institution information is known. For example, the example tool, discussed above, may access a general template associated with the example tool to determine if a user's name and institution information are stored at the general template.

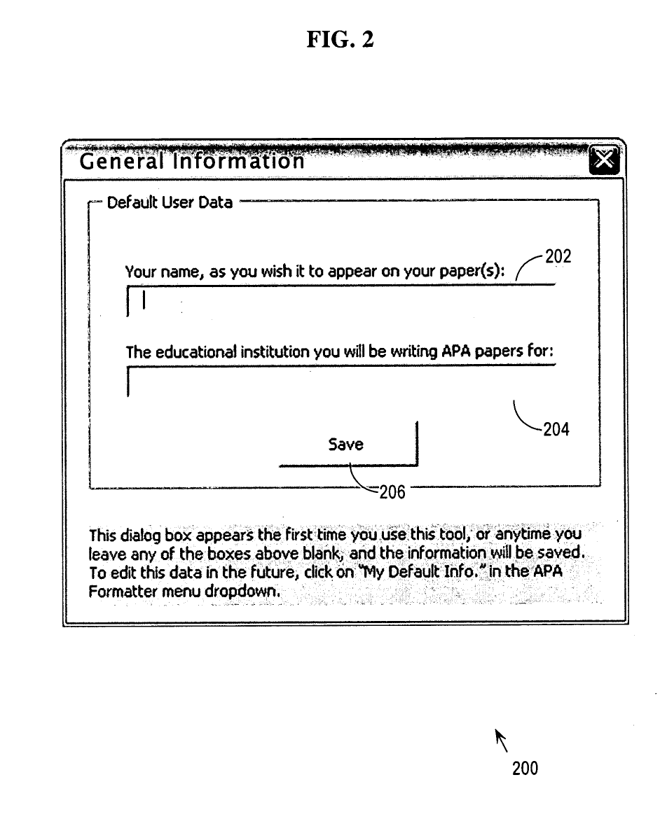

If a user's name and institution information are not known, then, at step 104, the user's name and institution information are collected. For example, the tool may display a graphical user interface (GUI), such as GUI 200 of FIG. 2, to collect the information. GUI 200 includes user interface (UI) elements 202 and 204 through which a user may input a name and institution information, respectively. The user may then activate UI control 206 to save the information to the general template associated with the tool.

Any manner of information may be collected and stored in such a general template, such as links to pictures, names of common co-authors, personalized document formatting information, i.e., which differs from the rules of the particular style guide, etc. Information stored in the general template may be included, upon document creation, in each document that is created with the example tool. Therefore, data provided by the user that is stored to the general template, such as the user's name and institution information, need not be provided more than once.

Additionally, a user may edit or remove information stored in the general template. In one embodiment of the invention, each individual user has a distinct general template, which allows individualization of the information stored therein. In another embodiment of the invention, each individual instance of an example tool has a distinct general template associated therewith.

In another embodiment of the invention, information received through a GUI, such as GUI 200, or received in any other manner, may be stored in a local user registry. In this embodiment of the invention, at the time that a document is created through the tool, the tool retrieves information stored in the local user registry for inclusion in the document.

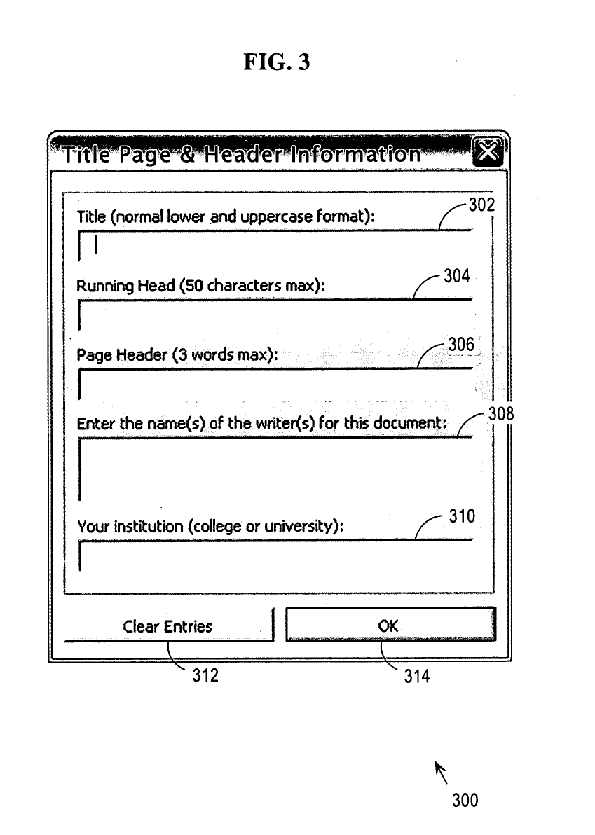

If the user's name and institution information are known at step 102 of method 100, or once the user's name and institution information are collected at step 104, method 100 continues to step 106. At step 106, information is collected for a title page and page headers of the particular document. Any combination of one or more GUIs may be used to collect information for the document within the embodiments of the invention. For example, the tool may display a title page editor GUI, such as GUI 300 of FIG. 3, to collect information for the title page and page headers of the document.

GUI 300 has the capacity to collect information for a title, a running head, a page header, writers of the document, and institution information through UI elements 302-310. UI element 308 allows a user to enter as many writers as needed for the particular document. The information listed in GUI 300 are example information items prescribed by the rules of the APA style guide being implemented by the example tool.

In one embodiment of the invention, the writers included in UI element 308 and the institution information input into UI element 310 are not saved to the general template, but are used only in the instance of the particular document. In yet another embodiment of the invention, UI elements 308 and 310 are initially populated automatically with information saved to the general template.

The example tool may automatically format one or more information items input into UI elements 302-310 according to the rules of the particular style guide being implemented. For example, the APA style guide requires that a running head be in all capital letters. Thus, the example tool may automatically convert information that a user inputs into UI element 304 to all capital letters. As a further example, the tool may automatically capitalize one or more of the words in a title, or may capitalize the names of the writers. Such conversions may occur after the user has entered information into one or more of the UI elements and has clicked away from the UI element for any GUI used by the example tool, or may occur upon the tool inserting the information into the document, etc.

GUI 300 further includes UI controls 312 and 314. A user may activate UI control 312 to delete the information present in UI elements 302-310. When a user activates UI control 314, the user signifies that the user is finished inputting information into GUI 300.

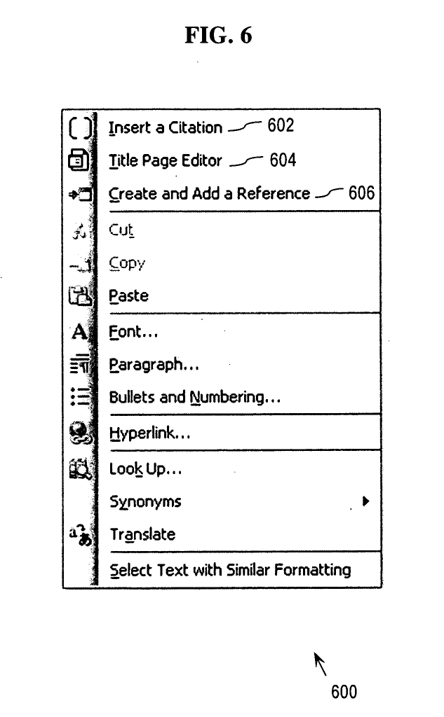

After the user has activated UI control 314, the user may continue to update information for the title and headers by accessing GUI 300. GUI 300 may be accessed by activating a UI control in the GUI of a word processing application in which the document is opened. GUI 300 may also be accessed through a right-click menu, as illustrated by UI control 604 included in GUI 600 of FIG. 6.

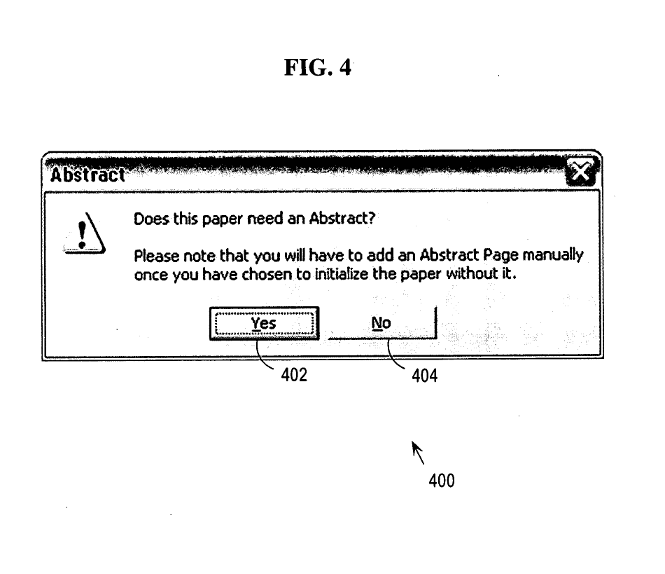

At step 108 of method 100, it is determined whether an abstract is needed. For example, the example tool may display GUI 400 of FIG. 4 to determine whether an abstract should be included in the document. GUI 400 includes UI controls 402 and 404, which, when activated by a user, indicate that an abstract should be included in the document, and should not be included in the document, respectively.

At step 110, a document is populated with the collected information and formatted according to the rules of a particular style guide. For example, the example tool activates the functionality of a word processing application, e.g., Microsoft Word, Corel WordPerfect, Apple Pages, etc., to populate the particular document with the collected information. The example tool further uses the functionality of the word processing application to format the document according to the rules of the APA style guide. The tool may format aspects of the document according to the rules, such as page margins, page numbers, etc.

A user may edit the populated document using the word processing application. The user may also manipulate the settings in the document that are pre-set by the example tool, just as with a document created outside of the example tool.

### Collecting Reference Information

Rules that govern the use and formatting of reference information are an important component of many style guides. Such rules may cover the formatting of references and in-text citations, and the location of reference information in the text of a document. For example, the APA style guide has rules about information items that are to be included in various different types of references, such as books, journals, podcasts, etc. According to the APA, a full reference, with all of the information for a particular information source, is included in a reference section of the text of a document. Also, a shorter in-text citation, including less information than the corresponding full reference, is included in appropriate locations in the text of the document, i.e., with text that contains information from the corresponding information source. For convenience of explanation, a full reference is referred to herein as a “reference”, and a short in-text citation is referred to herein as a “citation”, or an “in-text citation”.

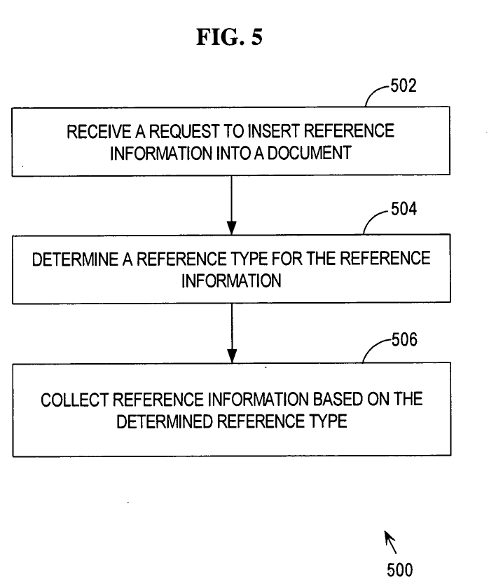

In one embodiment of the invention, a user concurrently inserts information for a particular reference into the text of a particular document and into the metadata of the particular document, as described in further detail hereafter. FIG. 5 illustrates an example method 500 of collecting information for a new reference.

At step 502, a request to insert reference information into a document is received. For example, the example tool may display a GUI presenting UI controls that, when activated, convey a request to insert reference information into the document. In one embodiment of the invention, the user may right-click on the text of the document to display GUI 600 of FIG. 6 that includes UI control 606 for indicating a request to create and add a reference. A user may also activate a UI control included in the GUI of the word processing application to indicate such a request.

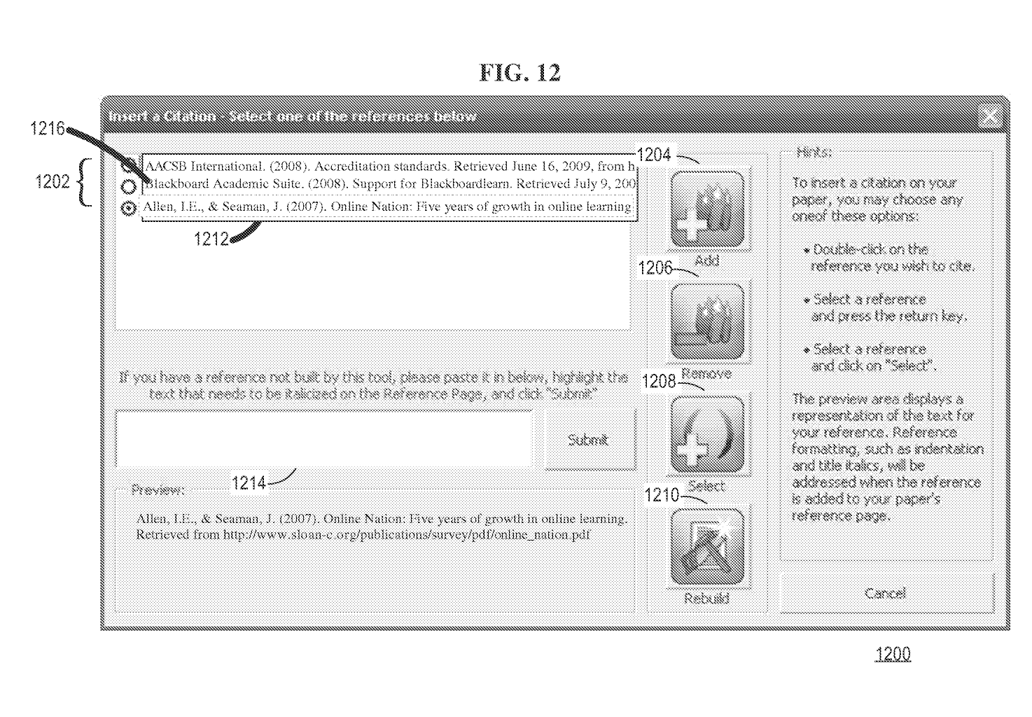

Other GUIs, such as GUI 1200 of FIG. 12 for inserting an in-text citation (described in more detail below), may include a UI control, i.e., UI control 1204, used to indicate a request to insert reference information into the document. GUI 1200 also includes a UI element 1214 for inserting a pre-formatted reference into the text and metadata of the document.

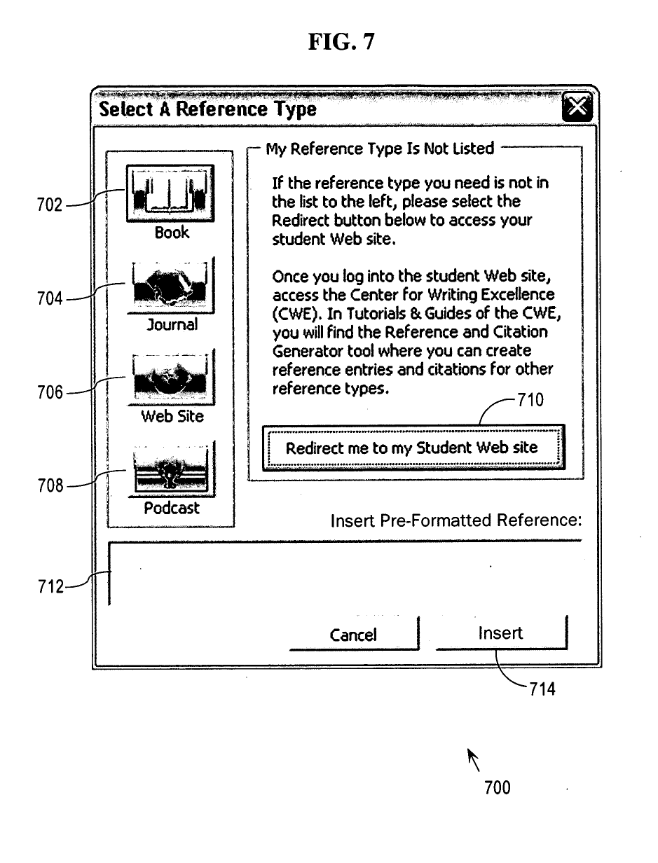

At step 504, a reference type for the reference information is determined. For example, the tool may display a GUI such as GUI 700 of FIG. 7 in response to the request to insert reference information into the document. GUI 700 includes UI controls 702-708, which represent, respectively, the reference information types: book, journal, Web site, and podcast. Such a GUI may include any combination of possible reference information types, including encyclopedias, pamphlets, legal documents, etc. A user may activate any of UI controls 702-708 to indicate a type of reference information.

In one embodiment of the invention, the example tool includes UI controls to aid a user with reference information that does not conform to one of the given reference types. For example, a user may have the option of connecting to a Web page configured to aid the user to format different types of references according to one or more style guides, i.e., through activation of UI control 710. If the example tool is associated with a particular university, then activation of UI control 710 may cause a browser to open a student aid page for the university.

Further, a user may have the option of including a pre-formatted reference in the document, i.e., through UI element 712. A user may type or paste a formatted reference into UI element 712 and activate UI control 714 to insert the reference into the text and metadata of the document.

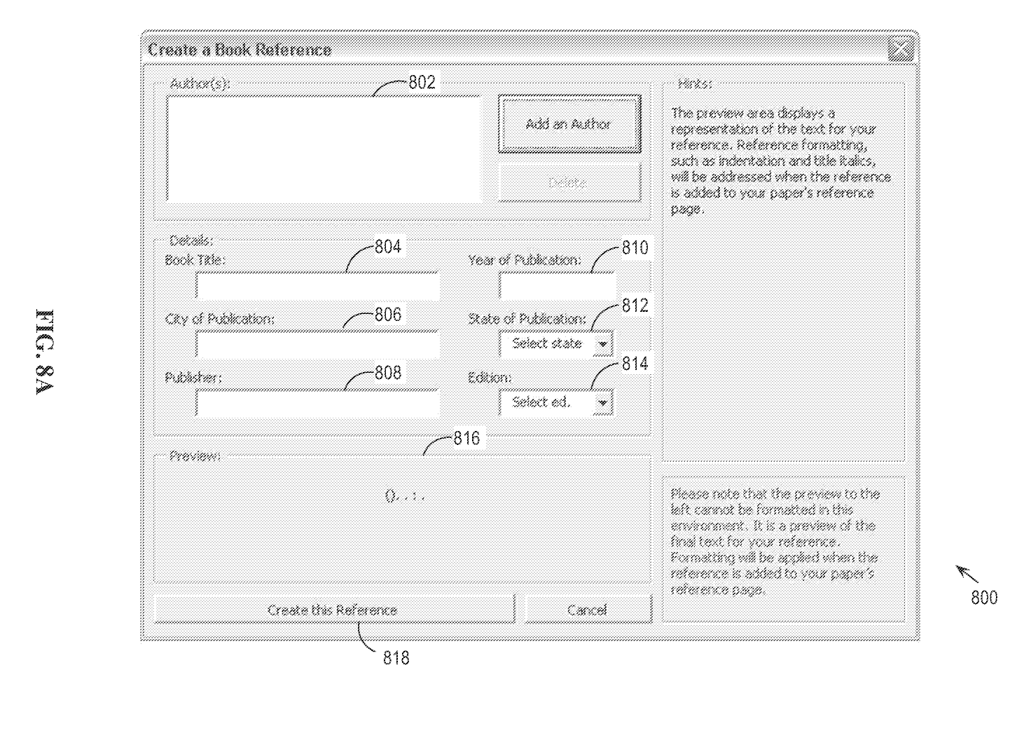

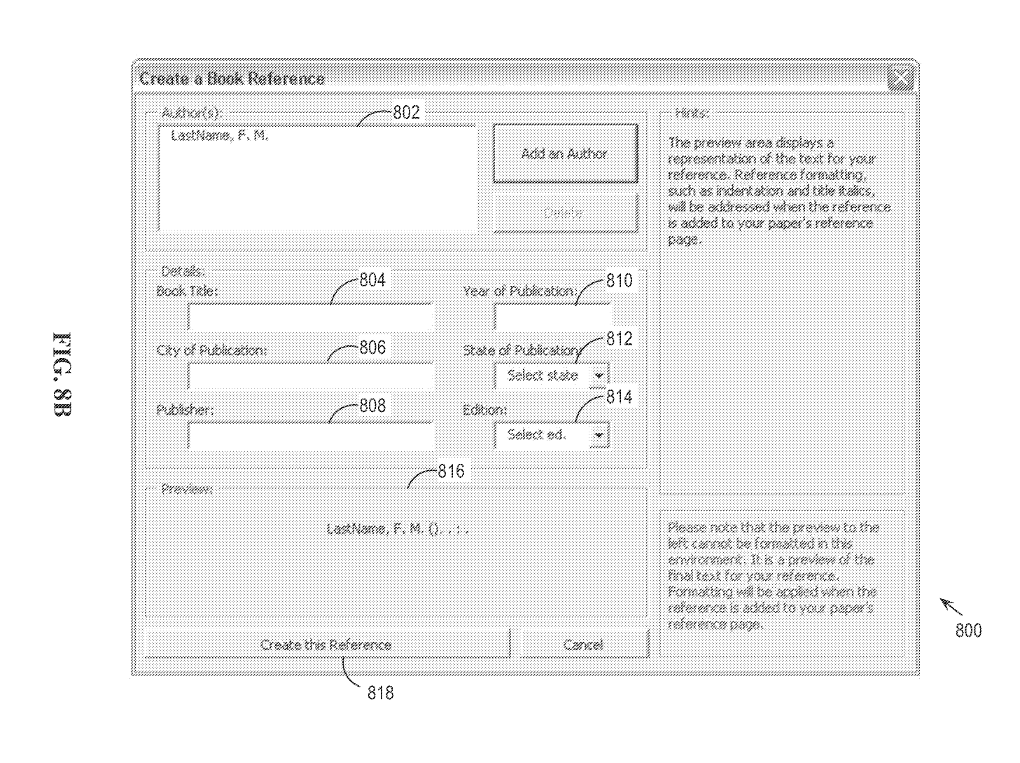

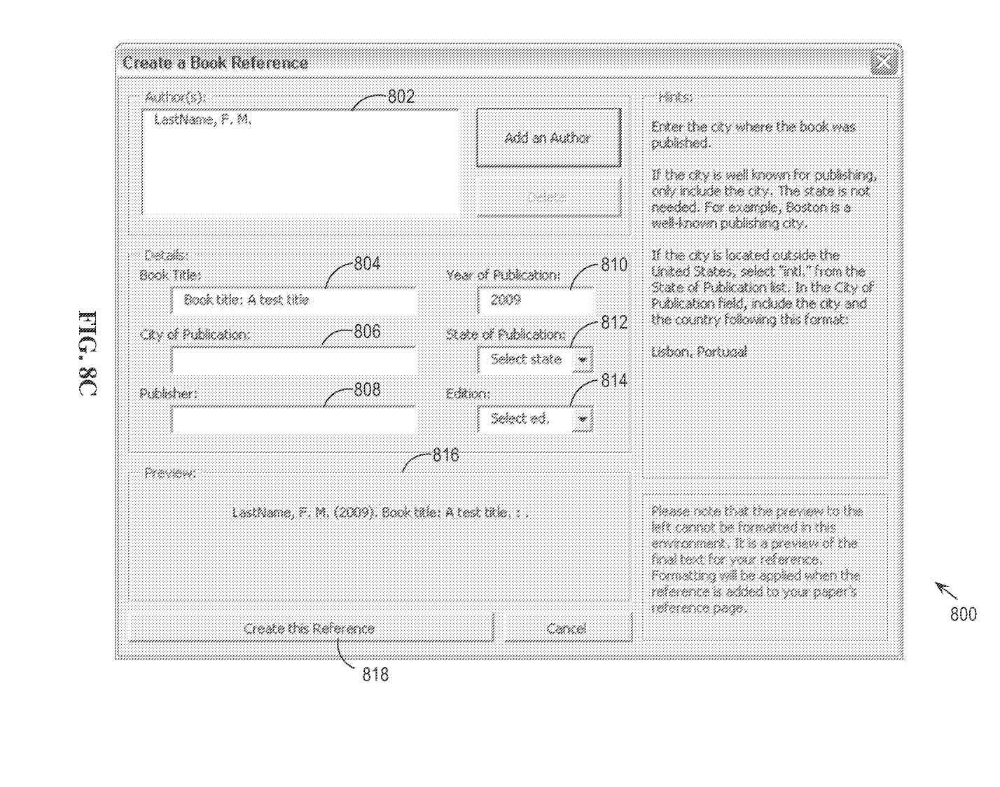

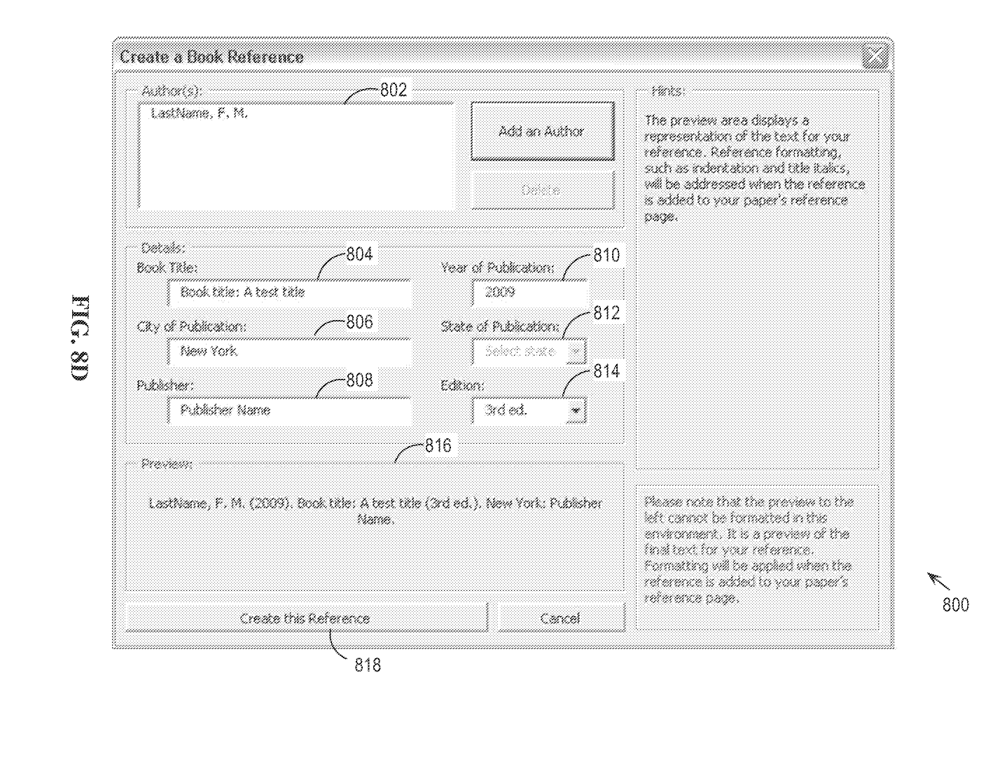

At step 506, reference information is collected based on the determined reference type. For example, if a user indicates a reference information type of books, i.e., through activation of UI control 702, the example tool may present a GUI, such as GUI 800 of FIG. 8A, to collect information for a book reference. GUI 800 includes UI elements 802-814 corresponding to author(s), book title, city of publication, publisher, year of publication, state of publication, and edition, respectively. Thus, GUI 800 requests all of the information prescribed by the rules of the APA style guide for a book reference type. A user may input information into one or more of UI elements 802-814 for inclusion in a particular reference. The example tool may also have other GUIs with UI elements tailored to other types of reference information.

### Dynamic Preview of Formatted References

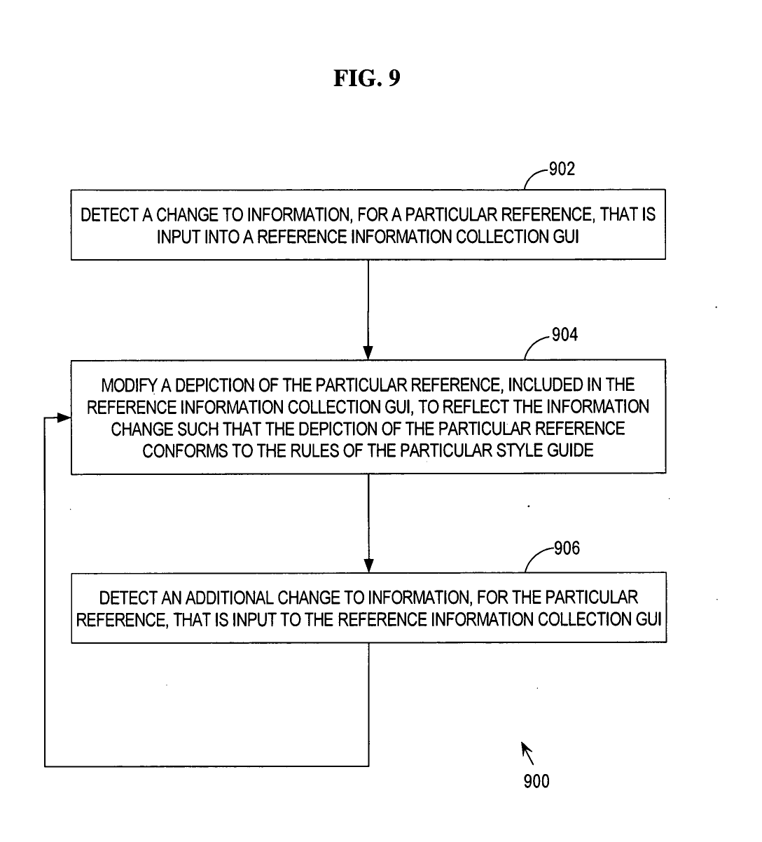

In one embodiment of the invention, GUI 800 includes a preview panel 816 that displays a depiction, conforming to the rules of a particular style guide, of the reference information being entered into UI elements 802-814. FIG. 9 illustrates an example method 900 of updating the formatted depiction of a particular book-type reference in preview panel 816. The functionality of a dynamic preview of a reference is not limited to book-type references, but may be implemented with respect to any reference type covered by the rules of a particular style guide.

At step 902, a change is detected to information for the particular reference. The information for the reference may have been changed, for example, by user input that affects the information in a reference information collection GUI. For example, the change may occur when a user adds an author to UI element 802, as shown in FIG. 8B. The example tool detects this change to the information being collected, which may be done in any number of ways within the embodiments of the invention. The information change may be detected upon the user typing a letter into a UI element of GUI 800, or may be detected upon the user clicking away from a UI element after making changes in the UI element, or by any other method.

At step 904, a depiction of the particular reference, included in the reference information collection GUI, is modified to reflect the information change such that the depiction of the particular reference both (a) reflects the change to the information, and (2) continues to conform to the rules of the particular style guide. For example, preview panel 816 of FIG. 8B includes the author name that the user has input into UI element 802, “LastName, F. M.” The format of the depiction of the particular reference in preview panel 816 conforms to the example style guide, the APA style guide, which requires that the author of any kind of reference be included at the beginning of a formatted full reference.

As a user includes new information in the reference information collection GUI, the depiction of the particular reference in the GUI is updated to include the new information such that the depiction continues to conform to the rules of the style guide. Thus, at step 906, an additional change to information, for the particular reference, that is input into the reference information collection GUI is detected. This detection returns example method 900 to step 904 to modify the depiction of the particular reference in the GUI to reflect the additional information change such that the depiction of the particular reference conforms to the rules of the style guide.

To illustrate the sequence of step 906 to step 904 of method 900, FIG. 8C shows GUI 800 with information included therein that was not included in FIG. 8B. Specifically, UI element 804 includes a book title “Book title: A test title”, and UI element 810 includes a year of publication, “2009”. The depiction of the reference in preview panel 816 of FIG. 8C includes this new information, formatted according to the example rules of the APA style guide. Specifically, the APA style guide indicates that the year of publication for a book should be included in parenthesis after the author, and that the title of a book should be included after a period subsequent to the year of publication.

In one embodiment of the invention, shown in FIGS. 8C and 8D, the depiction of the reference does not show certain formatting for the reference required by the rules of a particular style guide, such as italicized font. For example, the APA style guide indicates that the title of a book should be italicized. However, GUI 800 of FIGS. 8C and 8D do not show the book title as italicized. In this embodiment, the reference text inserted into the text of the document for the depicted reference follows the rules of the particular style guide, including those formatting elements not depicted in the preview. Thus, the book title for the particular reference illustrated in GUI 800 is italicized upon insertion of the reference into the text of the particular document.

FIG. 8D illustrates a depiction of a reference in preview panel 816 that includes all information prescribed by the example rules of the APA style guide. In the example of FIG. 8D, “New York” is a well-known city and does not require a state of publication, according to the rules of the APA style guide. In one embodiment of the invention, the example tool detects a well-known city and indicates to the user that inputting a state of publication is not necessary for a reference with a well-known city, if this is appropriate based on the rules of the particular style guide.

In one embodiment of the invention, in response to receiving a particular new information item for the reference, the depiction of the particular reference is updated to include the new information item and one or more additional characters, such as punctuation, that was not included in the particular new information item. For example, upon a user providing a publication year for a book-type reference, the depiction may be updated to include the year, as well as a set of parenthesis surrounding the year that is required by the APA style guide. In this embodiment of the invention, the new information item may be an optional item, the punctuation for which is not initially included in the depiction of the formatted reference. Further, a depiction of the formatted text of a reference may be initially void of all characters, including punctuation, when no information has yet been entered into a reference information collection GUI.

Upon finishing entering information for a particular reference, a user may activate UI control 818 to include the particular reference in the document. In one embodiment of the invention, a user may activate UI control 818 with information input into one or more of UI elements 802-814 without requiring that any particular one of the UI elements be populated prior to activation of UI control 818.

### Concurrent Insertion of Reference Information into the Text and Metadata of a Document

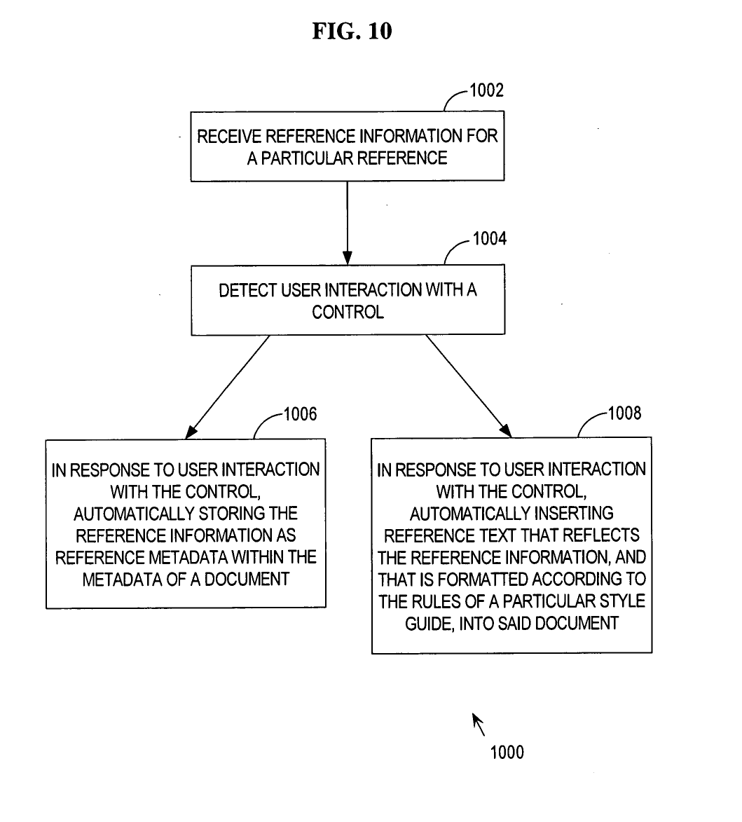

In one embodiment of the invention, the information for a particular reference, such as the information illustrated by FIG. 8D, is concurrently stored as reference metadata in the document and inserted as formatted reference text into the document. FIG. 10 illustrates an example method 1000 of inserting reference information as both text and metadata into a document.

At step 1002, reference information for a particular reference is received. In the previous example, information for a particular reference was received though GUI 800, of FIGS. 8B-8D. At step 1004, user interaction with a control is detected. For example, the example tool detects that a user activates UI control 818 of GUI 800.

At step 1006, in response to user interaction with the control, the reference information is automatically stored as reference metadata within the metadata of a document. In one embodiment of the invention, the reference information is stored in connection with the particular document, and not in the general template. In this manner, the reference information is available in the particular document, but is not present in other documents created based on the general template.

Reference information may be stored as name-value pairs in document variables that are part of the particular document. In one embodiment of the invention, the reference metadata is permanently saved to the metadata of the particular document only after a user saves the document through a word processing application after making a change to the metadata.

At step 1008, in response to user interaction with the control, reference text is automatically inserted into the document, where the reference text reflects the reference information and is formatted according to the rules of a particular style guide. For example, reference text formatted according to the rules of the example style guide, the APA style guide, is inserted into the text of the particular document.

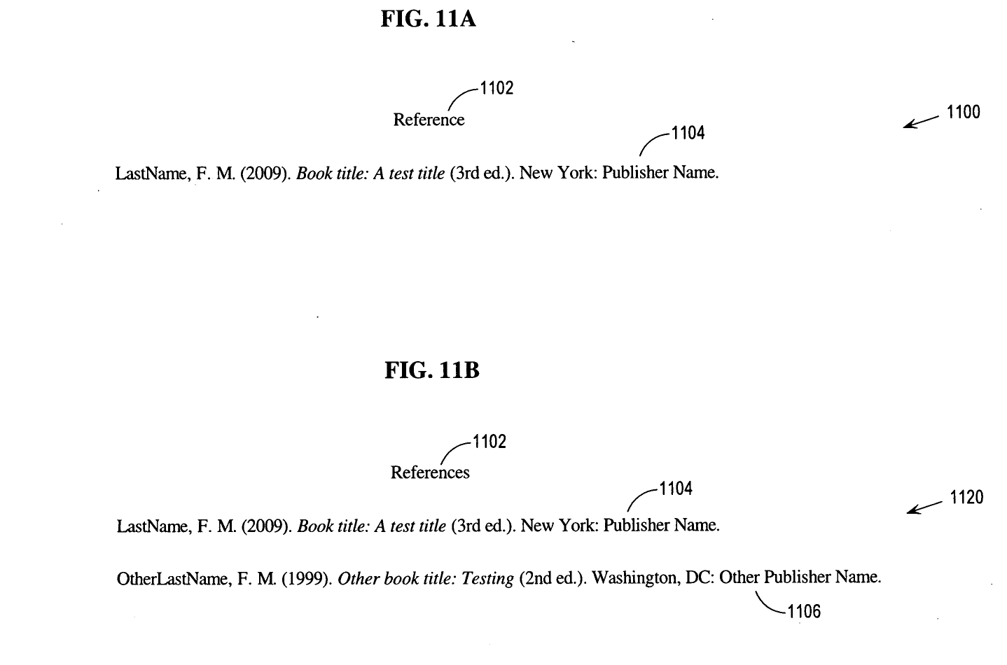

In one embodiment of the invention, the location at which the reference text is inserted is also based on the rules of a particular style guide. FIG. 11A illustrates an example reference section 1100 as prescribed by the example APA style guide. This reference section 1100 includes a heading 1102 and reference text 1104. In this embodiment of the invention, if a reference section is not present in a document when the example tool inserts reference text 1104, then the tool inserts heading 1102 with reference text 1104. If only one reference i.e., reference text 1104, is inserted in reference section 1100, then the inserted heading 1102 is singular, according to the rules of the APA style guide.

As illustrated by reference section 1120 of FIG. 11B, if a single reference, i.e., reference text 1104, is present in a reference section when the example tool inserts one or more additional references, i.e., reference text 1106, then the tool modifies heading 1102 to be plural. The references in a reference section, such as reference texts 1104 and 1106, may be automatically alphabetically sorted by the example tool.

As previously illustrated, the reference metadata for a particular reference is distinct from the reference text for the particular reference. Because reference information is stored as reference metadata in the metadata of the particular document itself, no information for the document is stored outside of the document. Such a document may be transmitted to another computer and retain all information inserted into the document without any additional supporting files.

If a user receives the document from the author and opens the particular document with a tool implementing the embodiments of the invention, the user has the same access to the metadata and features based on the metadata, explained in further detail below, as the author of the document. Any changes the receiving user saves to the text or metadata of the document are also stored in the document and are transmitted with the document.

In another embodiment, other information for the paper, such as information for the title page, headers, and other formatting information, etc., is also stored in the metadata of the document.

### Manipulating a Reference Section

In yet another embodiment of the invention, the reference section may be rebuilt based on the reference metadata in the metadata of the particular document. For example, a user may rebuild reference section 1120 based on the reference metadata stored in the document. GUI 1200 of FIG. 12 illustrates a UI control 1210 that, when activated, constitutes a request to rebuild a reference section of the document based on the metadata of the document.

Rebuilding a reference section may include deleting any reference section included in the particular document and inserting a rebuilt reference section in place of the deleted reference section. Such a rebuilt reference section may be constructed by identifying each individual reference reflected in the metadata of the document and constructing reference text based on the information for each reference found. The references may be formatted according to the rules of the particular style guide, and ordered according to rules of the style guide, e.g., in alphabetical order. The list of formatted references may be inserted into the text of the document, along with an appropriate heading.

A reference section, such as reference section 1120, may be intact upon the example tool receiving the request for rebuilding, which causes the tool to delete reference section 1120 and insert a rebuilt reference section. Furthermore, reference section 1120 may have been modified, partially deleted, or fully deleted before receiving the request for rebuilding the reference section. A modified or partially deleted reference section is also deleted upon rebuilding the reference section. In one embodiment of the invention, modifications that a user makes to a reference section that were not made through the example tool are deleted upon rebuilding the reference section, because such modifications are not reflected in the metadata of the document.

A user may also remove a reference from the metadata of the document by removing the reference from a list of references reflected in the metadata of the document. For example, GUI 1200 includes a reference list 1202 including all references reflected in the metadata of the particular document. A user may request that a particular reference of reference list 1202 be removed from the list by highlighting the particular reference and activating UI control 1206. If a user requests deletion of a particular reference from reference list 1202, then the reference is removed both from the metadata of the document, and from the text of the document. Furthermore, the removed reference would no longer be shown in reference list 1202 because the reference would no longer be reflected in the metadata of the document. In one embodiment of the invention, all in-text citations created based on the removed reference are also deleted.

If the only reference present in the reference section of the document is deleted, then the reference section heading is also deleted from the document. Furthermore, if the user removes all but one reference from the metadata and text of the document, the reference section heading may be modified by the example tool to be singular.

If a user deletes the text of a reference or an in-text citation from the text of the document without requesting removal of the corresponding reference from the metadata of the document, then the reference metadata for the reference remains in the metadata of the document, even when the reference text or in-text citation is deleted.

### Adding a Citation

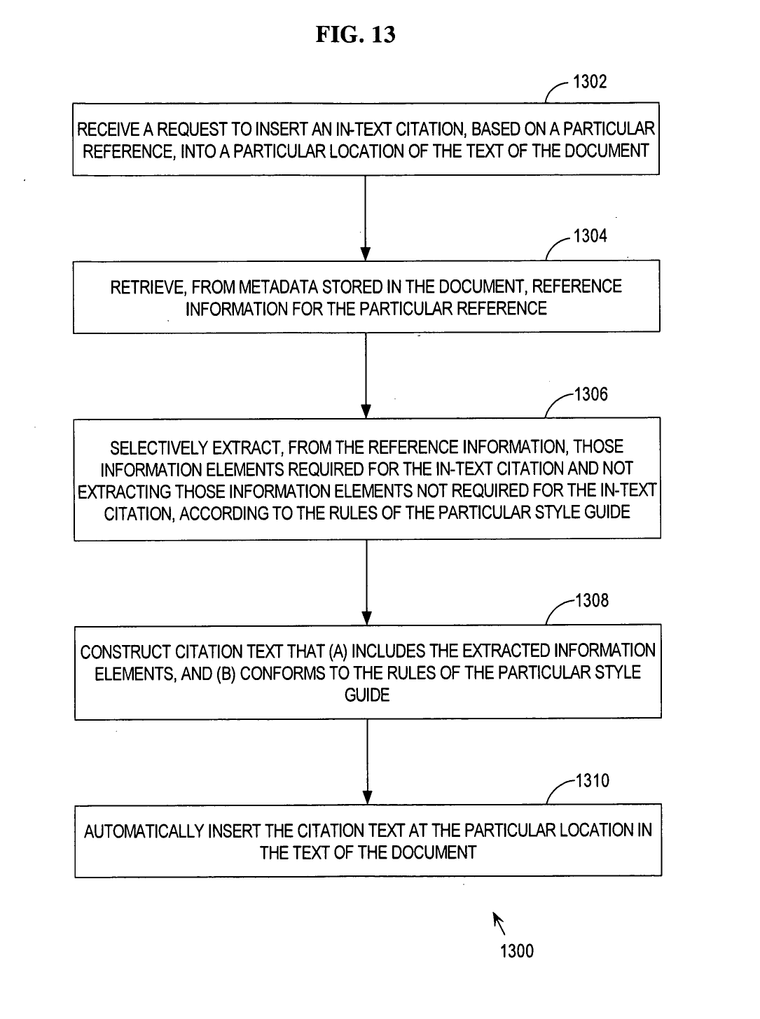

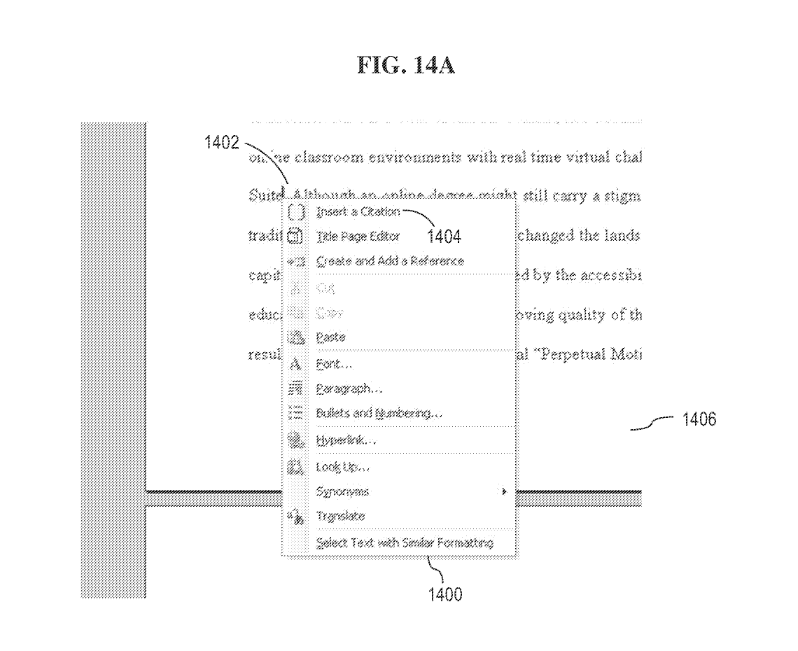

A user may add, to the text of the document, in-text citations based on information for particular references stored in the metadata of the document. A short in-text citation, which is based on a full reference, is commonly used inline with the text of a paper to refer to a source represented by a full reference placed elsewhere in the text. FIG. 13 illustrates an example method 1300 of formatting and inserting an in-text citation.

At step 1302, a request to insert an in-text citation, based on a particular reference, into a particular location of the text of the document is received. Such a request to insert an in-text citation may be submitted though a GUI, such as GUI 1200 of FIG. 12. GUI 1200 includes reference list 1202 that are included in the metadata stored in the particular document. A user may select one of the references in reference list 1202 on which to base an in-text citation, e.g., reference 1212, in any number of ways within the embodiments of the invention. For example, the user may double-click on reference 1212 to select the reference. The user may also highlight reference 1212 and press ‘enter’, or highlight reference 1212 and activate UI control 1208 to select reference 1212 as the basis of an in-text citation.

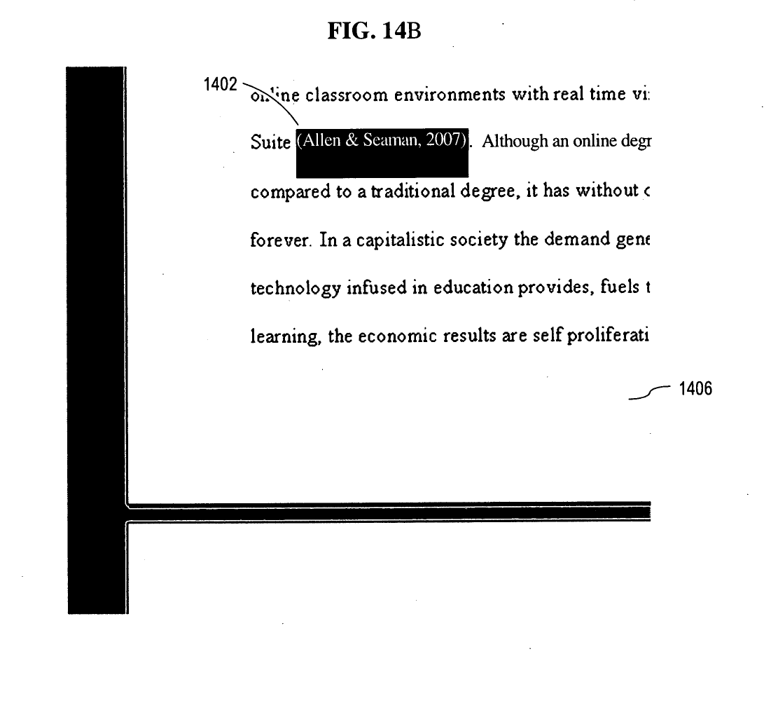

A user may request GUI 1200 in any of a number of ways within the embodiments of the invention. For example, as illustrated by GUI 1400 of FIG. 14A, the user may right-click on a particular location 1402 at which the user desires to insert the in-text citation in the text of the particular document, i.e., document 1406. In response to the right-click, GUI 1400 may be displayed, which includes UI control 1404 for inserting a citation. Also, the user may place a cursor at the particular location 1402 in the text of the document 1406 and activate a control in the GUI of a word processing application to request that an in-text citation be inserted at the particular location.

At step 1304, reference information for the particular reference is retrieved from metadata stored in the document. For example, the example tool retrieves a name-value pair with information for reference 1212, of FIG. 12, from the metadata of the particular document.

At step 1306, information elements required for the in-text citation, by the rules of the particular style guide, are selectively extracted from the reference information. Further at step 1306, those information elements not required for the in-text citation, by the rules of the particular style guide, are not extracted from the reference information. For example, the example rules of the APA style guide generally require that a basic in-text citation, associated with a particular reference having two human authors, include the last names of each author for the reference and the year associated with the reference. In this example, the tool extracts from the information retrieved for reference 1212 the last names of each author, i.e., “Allen” and “Seaman”, and the year for the reference, i.e., “2007”.

At step 1308, citation text is constructed that (a) includes the extracted information elements, and (b) conforms to the rules of the particular style guide. For example, the example tool constructs citation text for reference 1212 as follows: “(Allen & Seaman, 2007)” according to the rules of the example APA style guide. The constructed citation text includes the information elements extracted from the reference information for reference 1212.

In one embodiment of the invention, if a user inserted the reference for the in-text citation into the document as a pre-formatted reference, i.e., through UI element 1214 of GUI 1200, then the tool may parse the reference to extract information that is most likely to be included in the in-text citation. For example, reference 1216 is a pre-formatted reference inserted into the document through UI element 1214. The example tool may extract the initial words of the reference that precede a period or a comma, i.e., “Blackboard Academic Suite”, for inclusion in the in-text citation. The example tool may also parse the pre-formatted reference to find information that is likely a year. In the case of reference 1216, the example tool may extract “2008” as the year for the reference. Thus, the example tool may format citation text for pre-formatted reference 1216 as “(Blackboard Academic Suite, 2008)”.

At step 1310, the citation text is automatically inserted at the particular location in the text of the document. In the example of FIG. 14B, the example tool inserts the constructed citation text, “(Allen & Seaman, 2007)”, into the particular location 1402 in the text of the document 1406, as previously indicated by the user, described in connection with GUI 1400 of FIG. 14A.

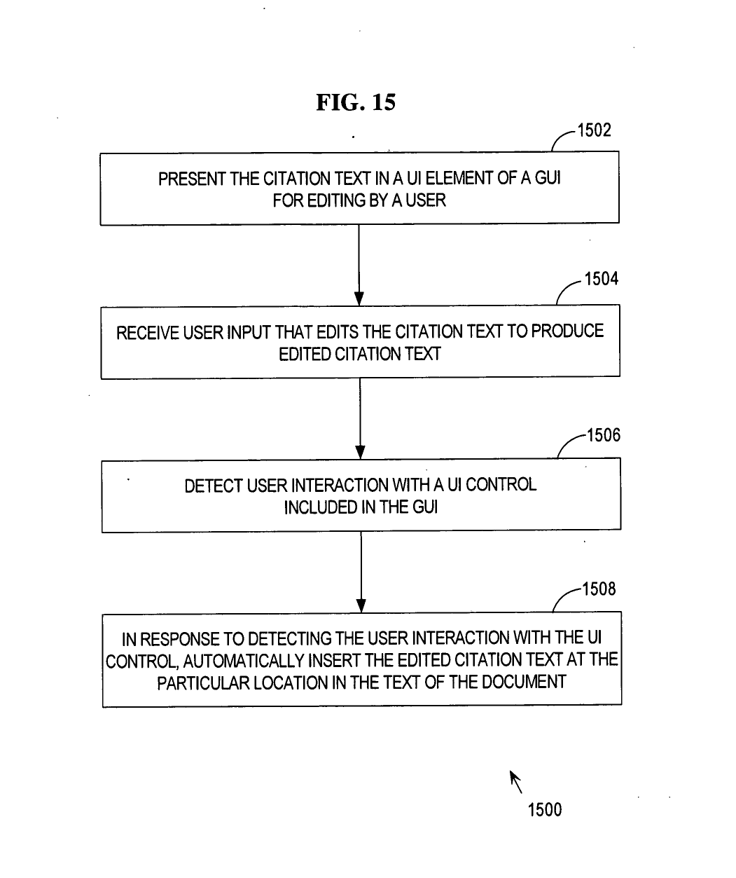

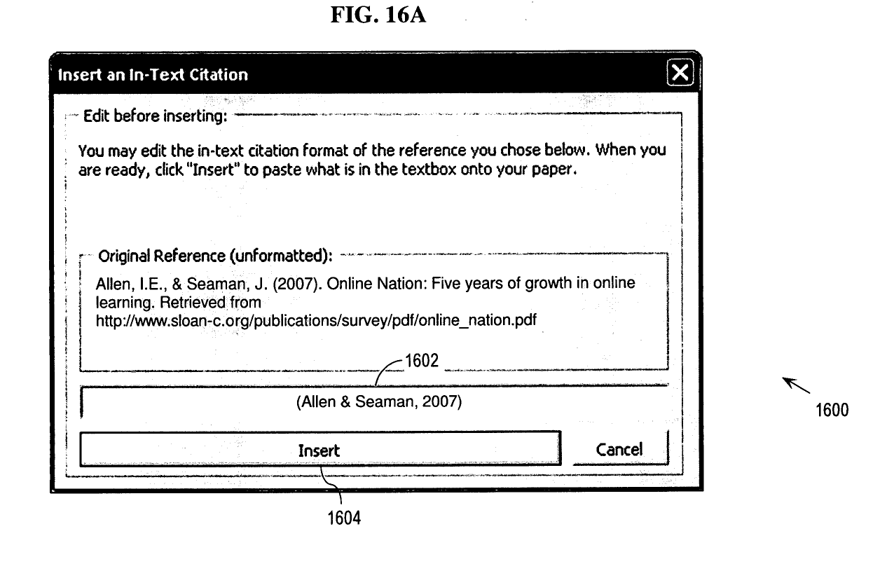

In one embodiment of the invention, the constructed citation text is presented to a user for editing prior to inserting the citation text into the text of the particular document. FIG. 15 illustrates an example method 1500 of receiving user input that edits citation text, and inserting the edited citation text into the text of the document.

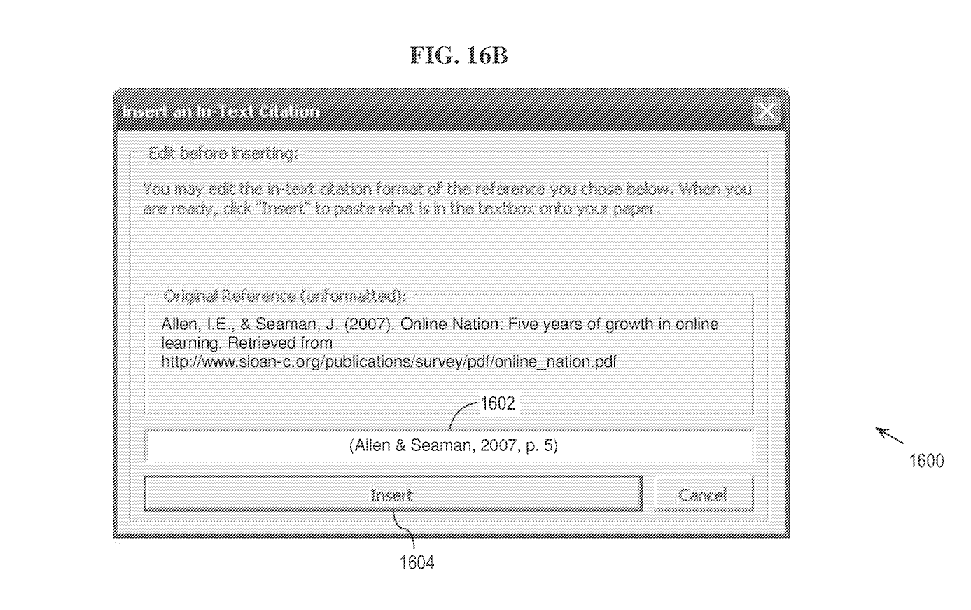

At step 1502, the citation text is presented in a UI element of a GUI for editing by a user. For example, the example tool may display a GUI, such as GUI 1600 of FIG. 16A, that displays the formatted citation text 1602, “(Allen & Seaman, 2007)”, for editing by a user. In this example, the UI element in which the citation text 1602 is presented is an editable text box.

At step 1504, user input, which edits the citation text to produce edited citation text, is received. The user may edit the in-text citation, as illustrated by FIG. 16B. In FIG. 16B the citation text 1602 is edited by a user to be “(Allen & Seaman, 2007, p. 5)”.

At step 1506, user interaction with a UI control included in the GUI is detected. For example, a user may activate UI control 1604 of GUI 1600 to indicate that the citation text 1602, including any edits made by the user, should be inserted into the text of the document.

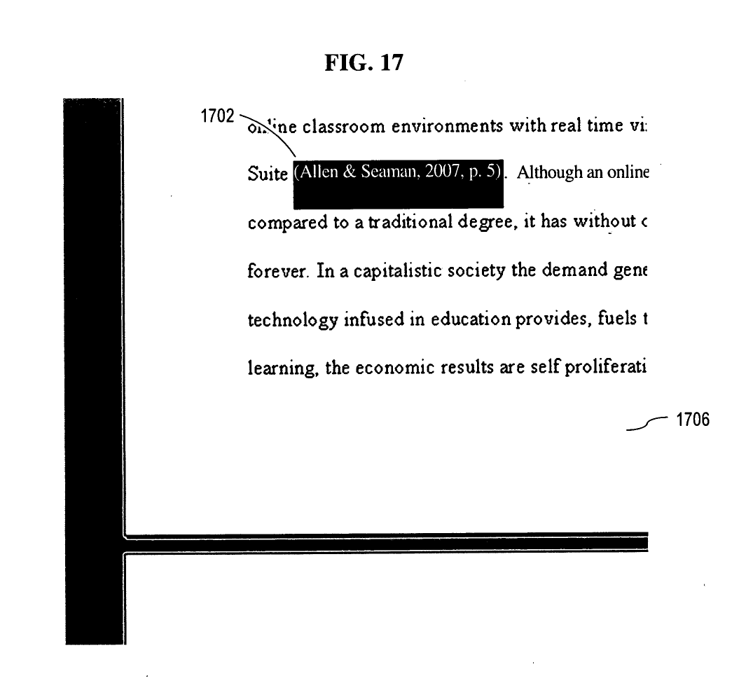

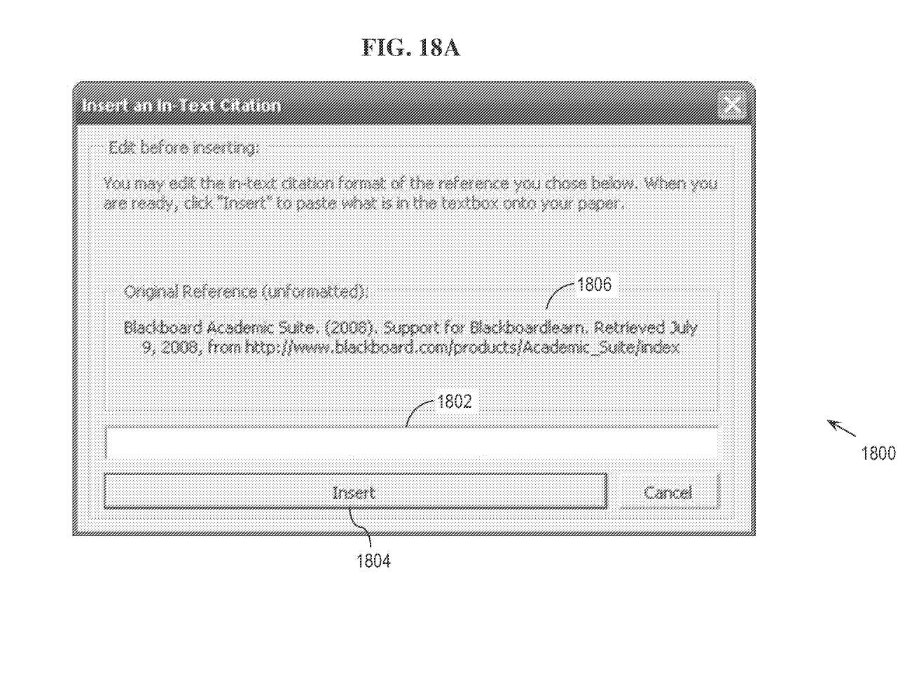

At step 1508, in response to detecting the user interaction with the UI control, the edited citation text is automatically inserted at the particular location in the text of the document. As illustrated in FIG. 17, “(Allen & Seaman, 2007, p. 5)” is inserted into the location in the text of the document previously indicated by the user, i.e., the particular location 1402 of FIGS. 14A and 14B, shown as location 1702 in FIG. 17.

A user may desire to edit a citation formatted by the example tool for any number of reasons. As in the above example, the user may edit the citation to include a page number in the citation text. The user may change a citation with multiple authors to list only the first author and the signal “et al.” to represent the rest of the authors for the reference. Furthermore, if the reference is of a type unknown to the tool, as described above, the user may modify the information included in the in-text citation by the tool.

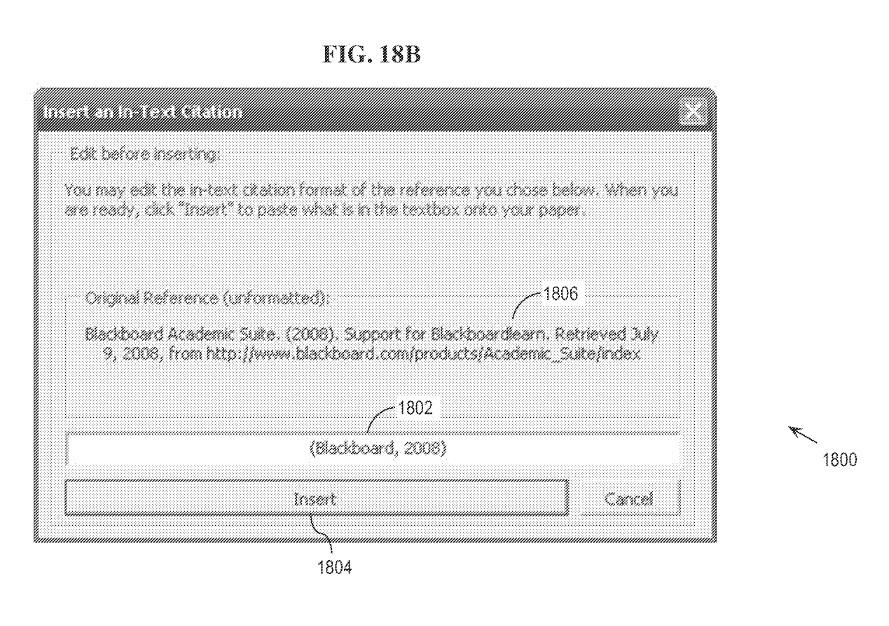

In one embodiment of the invention, if a user has entered a particular reference as a pre-formatted reference, i.e., through UI element 1214 of GUI 1200, then the tool records the particular reference as a pre-formatted reference. Thus, upon a request to insert an in-text citation into the text of the document based on the particular reference, the tool requests that the user supply the tool with an in-text citation for the particular reference, i.e., through GUI 1800 of FIG. 18A.

In the example of GUI 1800, a user has requested that an in-text citation be inserted for reference 1806, which is a pre-formatted reference. GUI 1800 includes a blank UI element 1802 through which a user may enter an in-text citation for reference 1806. GUI 1800 of FIG. 18B includes an in-text citation in UI element 1802 that has been input by a user. The user may then activate UI control 1804 to insert the in-text citation into the document, as described with respect to certain embodiments of the invention.

### Opening the Produced Document

If a document created through a tool implementing embodiments of the invention is opened outside of the tool, the document can be manipulated with a word processing application as if the document were created by the word processing application without the example tool. All of the information included in the text of the document through the example tool is viewable and available for normal editing through the word processing application.

In one embodiment of the invention, a user may open an existing document with the example tool. All information stored in the metadata of the document is available to the user that opens the document using the example tool.

### Alternative Embodiments

In one embodiment of the invention, the example tool may be implement as a Microsoft Word template that is configured to activate a Visual Basic macro embedded in the template. Activation of such a Microsoft Word template automatically launches Microsoft Word and the embedded macro. The macro may contain code for the GUIs described herein. Such a macro is easily tailored to the standards of a particular style guide.

According to one embodiment, the tool is built using the Microsoft Visual Studio Tools for Office (VSTO) environment, which is an environment that leverages the Microsoft .NET technology to work with the Microsoft Office Suite.

According to another embodiment, the tool is built using Visual Basic for Applications (VBA) code, using the Visual Basic Editor (VBE) integrated into each Microsoft Office product.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

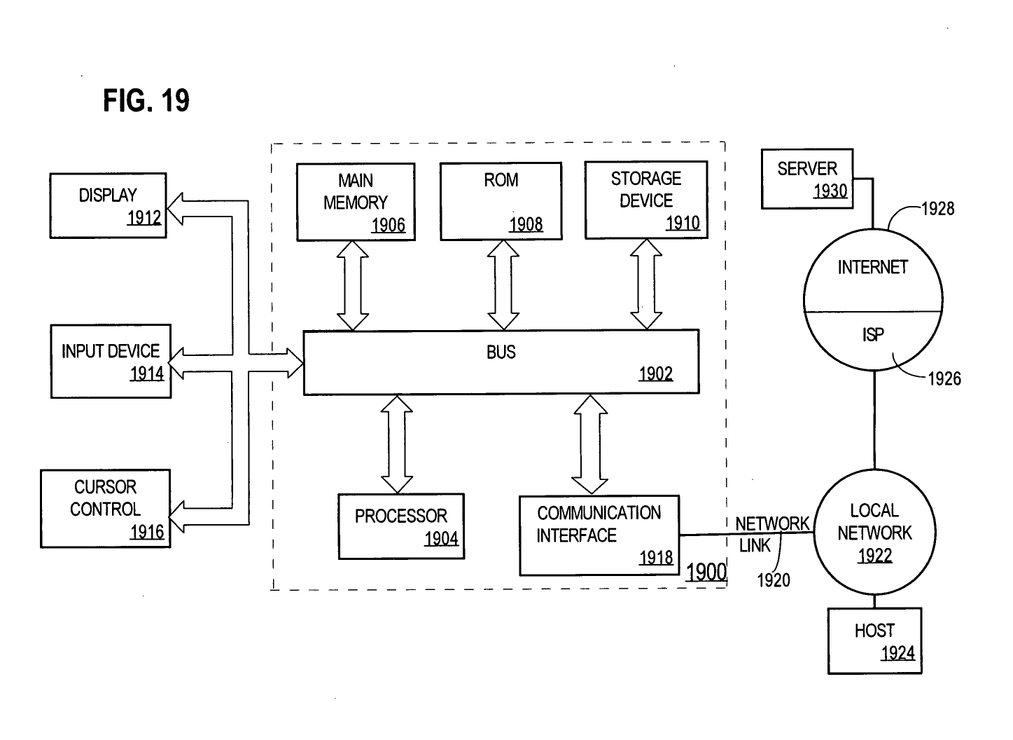

For example, FIG. 19 is a block diagram that illustrates a computer system 1900 upon which an embodiment of the invention may be implemented. Computer system 1900 includes a bus 1902 or other communication mechanism for communicating information, and a hardware processor 1904 coupled with bus 1902 for processing information. Hardware processor 1904 may be, for example, a general purpose microprocessor.

Computer system 1900 also includes a main memory 1906, such as a random access memory (RAM) or other dynamic storage device, coupled to bus 1902 for storing information and instructions to be executed by processor 1904. Main memory 1906 also may be used for storing temporary variables or other intermediate information during execution of instructions to be executed by processor 1904. Such instructions, when stored in storage media accessible to processor 1904, render computer system 1900 into a special-purpose machine that is customized to perform the operations specified in the instructions.

Computer system 1900 further includes a read only memory (ROM) 1908 or other static storage device coupled to bus 1902 for storing static information and instructions for processor 1904. A storage device 1910, such as a magnetic disk or optical disk, is provided and coupled to bus 1902 for storing information and instructions.

Computer system 1900 may be coupled via bus 1902 to a display 1912, such as a cathode ray tube (CRT), for displaying information to a computer user. An input device 1914, including alphanumeric and other keys, is coupled to bus 1902 for communicating information and command selections to processor 1904. Another type of user input device is cursor control 1916, such as a mouse, a trackball, or cursor direction keys for communicating direction information and command selections to processor 1904 and for controlling cursor movement on display 1912. This input device typically has two degrees of freedom in two axes, a first axis (e.g., x) and a second axis (e.g., y), that allows the device to specify positions in a plane.

Computer system 1900 may implement the techniques described herein using customized hard-wired logic, one or more ASICs or FPGAs, firmware and/or program logic which in combination with the computer system causes or programs computer system 1900 to be a special-purpose machine. According to one embodiment, the techniques herein are performed by computer system 1900 in response to processor 1904 executing one or more sequences of one or more instructions contained in main memory 1906. Such instructions may be read into main memory 1906 from another storage medium, such as storage device 1910. Execution of the sequences of instructions contained in main memory 1906 causes processor 1904 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 1910. Volatile media includes dynamic memory, such as main memory 1906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1902. Transmission media can also take the form of acoustic or light waves, such as those generated during radio-wave and infra-red data communications.

Various forms of media may be involved in carrying one or more sequences of one or more instructions to processor 1904 for execution. For example, the instructions may initially be carried on a magnetic disk or solid state drive of a remote computer. The remote computer can load the instructions into its dynamic memory and send the instructions over a telephone line using a modem. A modem local to computer system 1900 can receive the data on the telephone line and use an infra-red transmitter to convert the data to an infra-red signal. An infra-red detector can receive the data carried in the infra-red signal and appropriate circuitry can place the data on bus 1902. Bus 1902 carries the data to main memory 1906, from which processor 1904 retrieves and executes the instructions. The instructions received by main memory 1906 may optionally be stored on storage device 1910 either before or after execution by processor 1904.

Computer system 1900 also includes a communication interface 1918 coupled to bus 1902. Communication interface 1918 provides a two-way data communication coupling to a network link 1920 that is connected to a local network 1922. For example, communication interface 1918 may be an integrated services digital network (ISDN) card, cable modem, satellite modem, or a modem to provide a data communication connection to a corresponding type of telephone line. As another example, communication interface 1918 may be a local area network (LAN) card to provide a data communication connection to a compatible LAN. Wireless links may also be implemented. In any such implementation, communication interface 1918 sends and receives electrical, electromagnetic or optical signals that carry digital data streams representing various types of information.

Network link 1920 typically provides data communication through one or more networks to other data devices. For example, network link 1920 may provide a connection through local network 1922 to a host computer 1924 or to data equipment operated by an Internet Service Provider (ISP) 1926. ISP 1926 in turn provides data communication services through the world wide packet data communication network now commonly referred to as the “Internet” 1928. Local network 1922 and Internet 1928 both use electrical, electromagnetic or optical signals that carry digital data streams. The signals through the various networks and the signals on network link 1920 and through communication interface 1918, which carry the digital data to and from computer system 1900, are example forms of transmission media.

Computer system 1900 can send messages and receive data, including program code, through the network(s), network link 1920 and communication interface 1918. In the Internet example, a server 1930 might transmit a requested code for an application program through Internet 1928, ISP 1926, local network 1922 and communication interface 1918.

The received code may be executed by processor 1904 as it is received, and/or stored in storage device 1910, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-executed method for formatting text according to a particular set of pre-defined rules comprising:
receiving reference information;
in response to user interaction with a control, automatically performing:
storing the reference information as reference metadata within metadata of a document, and
inserting reference text that reflects said reference information into the text of said document;
wherein the reference text is formatted according to said rules;
wherein the reference metadata is distinct from the reference text; and
wherein the method is performed by one or more computing devices.

2. The computer-executed method of claim 1, further comprising:
based on the rules, automatically selecting a location, within said document, at which to insert the reference text;
wherein the rules pertain to a particular style guide.

3. The computer-executed method of claim 2,
wherein the location at which to insert the reference text is a reference section;
wherein the step of inserting the reference text that reflects said reference information into said document further comprises:
determining whether the reference section includes a heading;
in response to determining that the reference section does not include a heading, automatically including a heading in the reference section;
in response to determining that the reference section includes a heading:
determining whether the reference section reflects one and only one previously-entered reference;
in response to determining that the reference section reflects one and only one previously-entered reference, modifying the heading of the reference section.

4. The computer-executed method of claim 1, further comprising:
receiving a request to rebuild an original reference section of said document;
in response to receiving the request to rebuild the original reference section, inserting a rebuilt reference section, based at least in part on the reference metadata, into the text of said document;
wherein the rebuilt reference section includes said reference text.

5. The computer-executed method of claim 4, wherein the original reference section includes said reference text.

6. The computer-executed method of claim 4, wherein the original reference section does not include said reference text.

7. The computer-executed method of claim 1, further comprising continuing to maintain the reference metadata in the metadata of said document after a user deletes said reference text from the text of said document.

8. The computer-executed method of claim 1, further comprising:
in response to receiving a request to remove from said document a particular reference:
removing said reference metadata from the metadata of the document; and
deleting said reference text from the text of said document.

9. The computer-executed method of claim 8, wherein receiving the request to remove from said document the particular reference further comprises:
displaying, in a user interface, a list of references represented in the metadata of the document;
wherein the user interface comprises one or more controls for removing a reference from said document; and
detecting the request to remove from said document said particular reference through the one or more controls.

10. The computer-executed method of claim 1, further comprising:
receiving a request to insert an in-text citation, based on a particular reference, into a particular location of the text of the document;
in response to the request to insert the in-text citation, performing the steps of:
retrieving, from the metadata of the document, the reference information for the particular reference;
wherein the reference information comprises (a) a first set of one or more information elements that are required for the in-text citation, according to the particular set of pre-defined rules, according to the particular set of pre-defined rules, and (b) a second set of one or more information elements that are not required for the in-text citation, according to the particular set of pre-defined rules;
selectively extracting, from the reference information, those information elements in the first set of one or more information elements and not extracting those information elements in the second set of one or more information elements, to produce extracted information elements;
constructing citation text that (a) includes the extracted information elements, and (b) conforms to the particular set of pre-defined rules.

11. The computer-executed method of claim 1, further comprising:
presenting a user interface, comprising a plurality of UI elements, that allows a user to enter information items for a particular reference reflected in the reference information;
displaying, in the user interface, a depiction, of the particular reference, that (a) is based on information items that the user has previously entered into the user interface, and (b) conforms to the particular set of pre-defined rules; and
as the user enters new information items via one or more of the UI elements, continuously updating the depiction of the particular reference to cause the depiction to (a) reflect the previously-entered and newly-entered information, and (b) continue to conform to the particular set of pre-defined rules.

12. A computer-executed method for displaying the format of a particular reference comprising:
presenting a user interface, comprising a plurality of UI elements, that allows a user to enter information items for the particular reference;
displaying, in the user interface, a depiction, of the particular reference, that (a) is based on information items that the user has previously entered into the user interface, and (b) conforms to a particular set of pre-defined rules; and
as the user enters new information items via one or more of the UI elements, continuously updating the depiction of the particular reference to cause the depiction to (a) reflect the previously-entered and newly-entered information, and (b) continue to conform to the particular set of pre-defined rules;
wherein the method is performed by one or more computing devices.

13. The computer-executed method of claim 12 further comprising:
receiving a particular new information item through a particular UI element of the user interface;
in response to receiving the particular new information item, adding to the depiction of the particular reference (a) the particular new information item, and (b) one or more additional characters not included in the particular new information item;
wherein the particular new information item comprises one or more characters.

14. A computer-executed method comprising:
receiving a request to insert an in-text citation, based on a particular reference, into a particular location of the text of a document;
in response to the request to insert the in-text citation, performing the steps of:
retrieving, from metadata stored in the document, reference information for the particular reference;
wherein the reference information comprises (a) a first set of one or more information elements that are required for the in-text citation, according to a particular set of pre-defined rules, according to the particular set of pre-defined rules, and (b) a second set of one or more information elements that are not required for the in-text citation, according to the particular set of pre-defined rules;
selectively extracting, from the reference information, those information elements in the first set of one or more information elements and not extracting those information elements in the second set of one or more information elements, to produce extracted information elements;
constructing citation text that (a) includes the extracted information elements, and (b) conforms to the particular set of pre-defined rules; and
automatically inserting the citation text at the particular location of the text of the document;
wherein the method is performed by one or more computing devices.

15. The computer-executed method of claim 14 further comprising:
prior to inserting the citation text into the text of the document:
presenting the citation text in a UI element of a GUI for editing by a user;
receiving user input that edits the citation text to produce edited citation text;
detecting user interaction with a UI control included in the GUI;
in response to detecting the user interaction with the UI control, automatically inserting the edited citation text at the particular location in the text of the document.

16. The computer-executed method of claim 14, wherein the step of receiving a request to insert an in-text citation further comprises detecting user selection of the particular reference from a list of references, displayed in a GUI, that are represented in the metadata of the document.

17. One or more storage media storing instructions which, when executed by one or more computing devices, cause performance of the method recited in claim 1.

18. One or more storage media storing instructions which, when executed by one or more computing devices, cause performance of the method recited in claim 2.

19. One or more storage media storing instructions which, when executed by one or more computing devices, cause performance of the method recited in claim 3.

20. One or more storage media storing instructions which, when executed by one or more computing devices, cause performance of the method recited in claim 4.

21. One or more storage media storing instructions which, when executed by one or more computing devices, cause performance of the method recited in claim 5.

22. One or more storage media storing instructions which, when executed by one or more computing devices, cause performance of the method recited in claim 6.

23. One or more storage media storing instructions which, when executed by one or more computing devices, cause performance of the method recited in claim 7.

24. One or more storage media storing instructions which, when executed by one or more computing devices, cause performance of the method recited in claim 8.

25. One or more storage media storing instructions which, when executed by one or more computing devices, cause performance of the method recited in claim 9.

26. One or more storage media storing instructions which, when executed by one or more computing devices, cause performance of the method recited in claim 10.

27. One or more storage media storing instructions which, when executed by one or more computing devices, cause performance of the method recited in claim 11.

28. One or more storage media storing instructions which, when executed by one or more computing devices, cause performance of the method recited in claim 12.

29. One or more storage media storing instructions which, when executed by one or more computing devices, cause performance of the method recited in claim 13.

30. One or more storage media storing instructions which, when executed by one or more computing devices, cause performance of the method recited in claim 14.

31. One or more storage media storing instructions which, when executed by one or more computing devices, cause performance of the method recited in claim 15.

32. One or more storage media storing instructions which, when executed by one or more computing devices, cause performance of the method recited in claim 16.
